(19) United States
(12) Patent Application Publication
(10) Pub. No.: US 2020/0313755 A1
(43) Pub. Date: Oct. 1, 2020

(54) Assistance Information For Doppler Compensation In Non-Terrestrial Networks

(71) Applicant: MediaTek Inc., Hsinchu City (TW)

(72) Inventors: Chiao-Yao Chuang, Hsinchu City (TW); Gilles Charbit, Cambridge (GB); Pradeep Jose, Cambridge (GB); Abdelkader Medles, Cambridge (GB); Xuan-Chao Huang, Hsinchu City (TW); Shiang-Jiun Lin, Hsinchu City (TW)

(21) Appl. No.: 16/833,656

(22) Filed: Mar. 29, 2020

Related U.S. Application Data
(60) Provisional application No. 62/825,080, filed on Mar. 28, 2019.
(60) Provisional application No. 62/867,295, filed on Jun. 27, 2019.

(51) Int. Cl. H04B 7/185; H04B 7/195; H04L 5/00; H04W 76/27

(52) U.S. Cl. CPC H04B 7/1855; H04W 76/27; H04L 5/0048; H04B 7/195

(57) ABSTRACT

Various examples and schemes pertaining to utilization of assistance information for compensation for Doppler shift in non-terrestrial networks (NTNs) are described. A user equipment (UE) receives assistance information via an access link from a network node of an NTN such as a satellite or an unmanned aircraft system (UAS) platform. The UE then performs an operation with respect to communications with the network node based on the assistance information such as cell re-selection or beam switching.

### CROSS REFERENCE TO RELATED PATENT APPLICATION(S)

The present disclosure is part of a non-provisional application claiming the priority benefit of U.S. Patent Application Nos. 62/825,080 and 62/867,295, filed on 28 Mar. 2019 and 27 Jun. 2019, respectively. Contents of aforementioned applications are incorporated by reference in their entirety.

### TECHNICAL FIELD

The present disclosure is generally related to wireless communications and networking and, more particularly, to utilization of assistance information for compensation for Doppler shift in non-terrestrial networks (NTNs).

### BACKGROUND

Unless otherwise indicated herein, approaches described in this section are not prior art to the claims listed below and are not admitted as prior art by inclusion in this section.

A non-terrestrial network (NTN) refers to a network, or a segment of network(s), using radio frequency (RF) resources on board a satellite or an unmanned aircraft system (UAS) platform. A typical scenario of an NTN providing access to a user equipment (UE) involves either NTN transparent payload, with the satellite or UAS platform acting as a relay, or NTN regenerative payload, with a base station (e.g., gNB) on board the satellite or UAS platform.

In an NTN, a satellite forms multiple beams projecting on the Earth with each beam covering a certain area on the Earth. As the satellite is moving relative to the Earth, the beams are also moving. Herein, a “beam” refers to the coverage through a set of one or more antenna elements and thus, for different sets of antenna elements, the formed beam on the Earth can be adjusted to reduce overlap between beams. In case a UE is static on the Earth to receive a signal from the satellite, a serving beam of the static UE would change over time from one beam to another. When the satellite is at a low earth orbit (LEO), large values of Doppler shift and Doppler variation rates can be experienced due to the motion of the satellite. Accordingly, the satellite may pre-compensate for the Doppler shift during downlink transmissions, and the amount of pre-compensation is related to the satellite speed and the angle between the beam's boresight direction and the satellite's direction of movement. As the amount of pre-compensation for a moving beam is constant, different beams may have different amounts of pre-compensation. As a result, when the serving beam for a UE is switched from one beam to another due to the satellite's movement, there could be a significant frequency jump which could exceed 4 kHz. This is undesirable from the perspective of the UE and, hence, there is a need for a solution to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure aims to provide schemes, solutions, concepts, designs, methods and systems to address aforementioned issue associated with frequency jump. Specifically, various proposed schemes in accordance with the present disclosure aim to provide solutions pertaining to utilization of assistance information for compensation for Doppler shift in NTNs, thereby mitigating or otherwise minimizing the impact of frequency jump.

In one aspect, a method may involve a processor of an apparatus implemented in a UE receiving, from a network node of an NTN, assistance information via an access link. The method may also involve the processor performing an operation with respect to communications with the network node based on the assistance information.

In another aspect, an apparatus may include a communication device and a processor coupled to the communication device. The communication device may be configured to wirelessly communicate with a network node of an NTN such as a satellite or an UAS platform. The processor may receive, via the communication device, assistance information via an access link from the network node. The processor may also perform, via the communication device, an operation with respect to communications with the network node based on the assistance information.

It is noteworthy that, although description provided herein may be in the context of certain radio access technologies, networks and network topologies such as 5th Generation (5G), New Radio (NR) and NTN, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet of Things (IoT), Industrial Internet of Things (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example satellite communication environment in which various solutions and schemes in accordance with the present disclosure may be implemented.

FIG. 2 is a diagram of an example scenario in accordance with the present disclosure.

FIG. 3 is a diagram of an example scenario in accordance with the present disclosure.

FIG. 4 is a diagram of an example scenario in accordance with the present disclosure.

FIG. 5 is a block diagram of an example communication apparatus and an example network apparatus in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to utilization of assistance information for compensation for Doppler shift in NTNs. According to the present disclosure, a number of possible solutions may be implemented separately or jointly. That is, although these possible solutions may be described below separately, two or more of these possible solutions may be implemented in one combination or another.

As alluded to above, frequency jump during the switch of a serving beam could be significant from the downlink perspective of a UE. Assuming LEO=600 km with a beam spot diameter of 100 km, frequency carrier of 2 GHz and a maximum Doppler variation rate of −544 Hz/s, Doppler shift in 13.2 seconds would be 7.2 kHz (=13.2*544 Hz). Assuming Doppler pre-compensation with Doppler shift=0 Hz with respect to beam spot center, Doppler shift with a moving beam is in the range of [−3.6 kHz, +3.6 kHz] and the Doppler discontinuity between adjacent beam spots could be 7.2 kHz (=13.2*544 Hz). Typical satellite ephemeris may include trajectory and beam layout. Thus, it would be desirable that common Doppler pre-compensation with respect to the beam spot center is applied by the satellite and that the position of beam spot center is indicated to the UE.

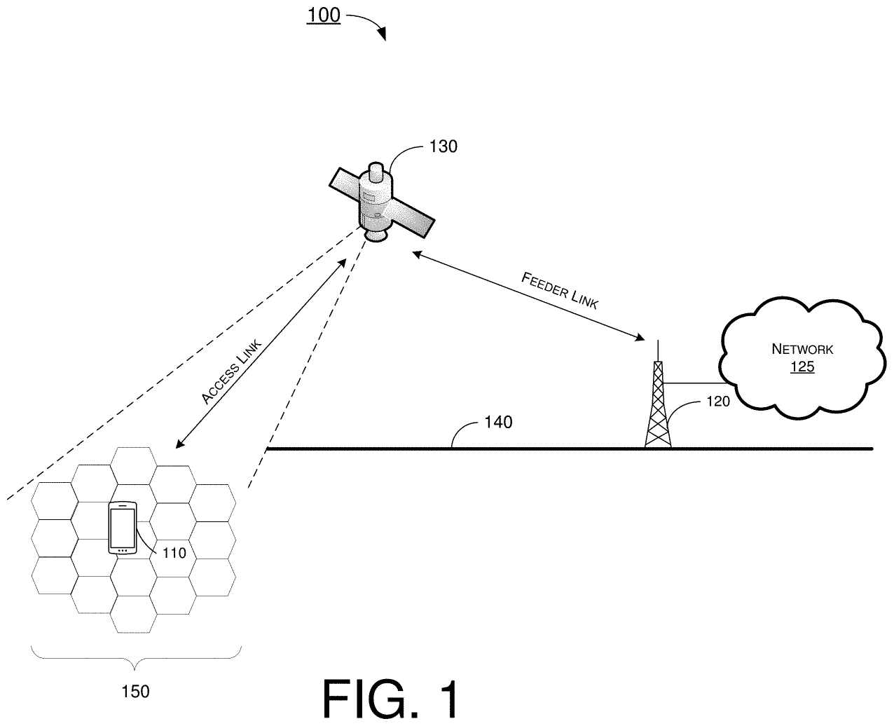

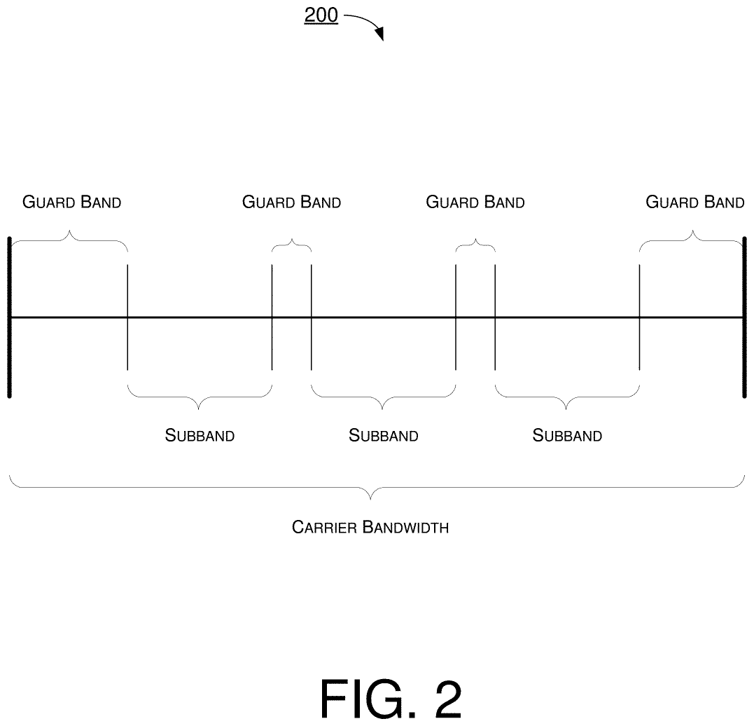

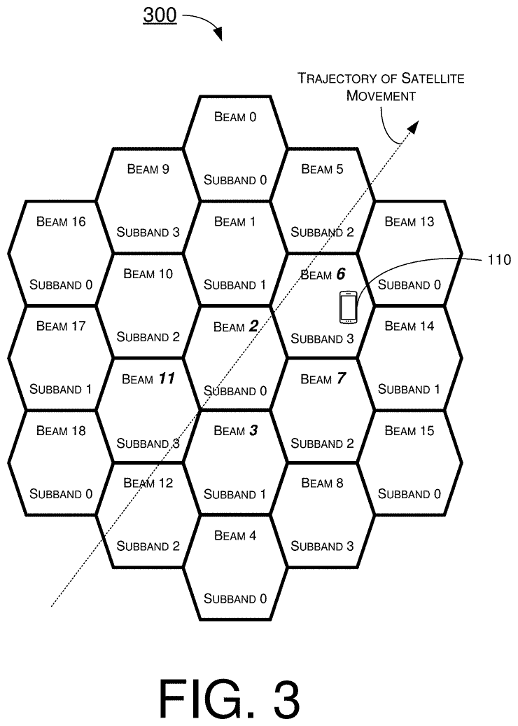

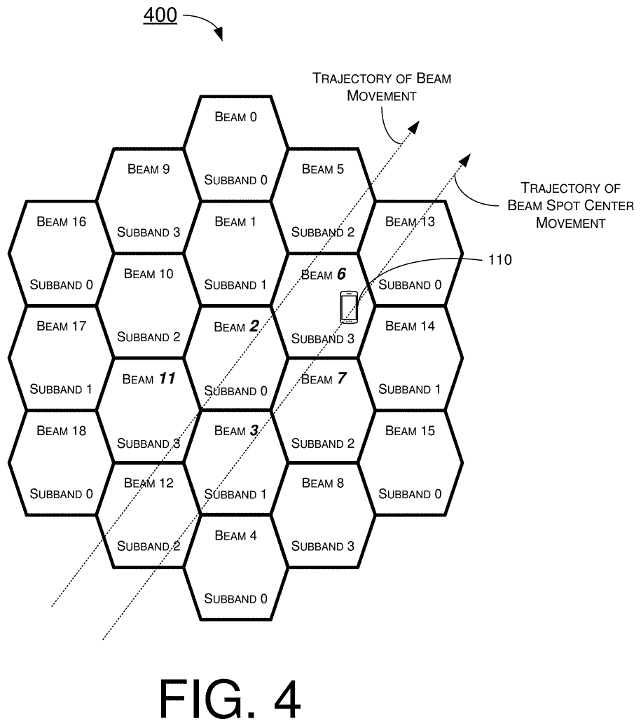

FIG. 1 illustrates an example non-terrestrial network (NTN) 100 in which various solutions and schemes in accordance with the present disclosure may be implemented. FIG. 2, FIG. 3 and FIG. 4 illustrate example scenarios 200, 300 and 400, respectively, in accordance with implementations of the present disclosure. Each of scenarios 200, 300 and 400 may be implemented in NTN 100. The following description of various proposed schemes is provided with reference to FIG. 1˜FIG. 4.

Referring to FIG. 1, NTN 100 may involve a UE 110, a network node 120 (e.g., a base station such as a gNB, eNB or transmit-receive point (TRP)) functioning as a gateway of a network 125 (e.g., a data network or a 5G mobile network), a satellite or UAS platform 130 orbiting around the Earth 140, and a plurality of beam footprints or cells 150. In NTN 100, UE 110 and satellite or UAS platform 130 may be in communication via an access link, and UE 110 and satellite or UAS platform 130 may implement various schemes pertaining to utilization of assistance information for compensation for Doppler shift in NTNs in accordance with the present disclosure, as described herein. It is noteworthy that, although examples and proposed schemes in accordance with the present disclosure are provided in the context of wireless networks (e.g., 5G/NR mobile networks), various proposed schemes in accordance with the present disclosure may also be applicable to other wireless technologies/networks (e.g., LTE/LTE-Advanced/LTE-Advanced Pro/NB-IoT/IIoT) and wired networks (e.g., Ethernet).

In NR, a carrier bandwidth for downlink transmission is divided into several subbands, and guard bands are allocated between every two adjacent subbands. Referring to FIG. 2, a guard band (which may comprise of a small number of resource blocks (RBs)) may be considered a potential digital frequency pre-compensation for each subband and the compensation quantity or amount for each subband may not be identical. In non-terrestrial networking, satellite or UAS platform 130 would transmit multiple beams. The half-power contour of a beam and that of the surrounding adjacent beams are non-overlapped or partially overlapped. Under a proposed scheme in accordance with the present disclosure, a subband may be arranged for data scheduling through each beam, and adjacent beams may be arranged by using different subbands in order to minimize or otherwise reduce interference from downlink perspective. For instance, the number of beams may be M and the number of subbands may be N, then M>=N. It is noteworthy that synchronization signal blocks (SSBs) are transmitted via each beam and, as the physical cell identity (PCI) for each beam is different, each beam may be assumed or considered as a cell. Under the proposed scheme, when a subband signal is transmitted through a corresponding beam, the frequency pre-compensation may be conducted for all the resource elements (REs) within that subband through digital frequency shift implementation before RF transmission. Thus, under the proposed scheme, transmission on an access link may be with a frequency re-use factor greater than 1 among the multiple beams.

Referring to FIG. 3, scenario 300 pertains to a scenario of beam moving trajectory. In the example shown in FIG. 3, UE 110 is in the coverage of beam 6. Under a proposed scheme in accordance with the present disclosure, assistance information may indicate the information of beam 2 and beam 7 which may be the candidates as the next beam to be the serving beam for UE 110 on the first tier. The assistance information may also indicate the information of beam 3 and beam 11 which may be the candidates of the beam after next beam to be the serving beam for UE 110 on the second tier.

Under a proposed scheme in accordance with the present disclosure, assistance information may be utilized to facilitate cell re-selection and to compensate for Doppler shift. Under the proposed scheme, during initial access, assistance information corresponding to the serving beam may indicate certain information. For instance, the assistance information may indicate information on the beams around the potential trajectory due to movement of satellite or UAS platform 130. Such information may include, for example and without limitation, PCIs of the beam candidates as the next beam (first tier) and PCIs of the beam candidates as the beam after the next beam (second tier).

The information may also include SSB information of the beam candidates as the next beam (first tier) (e.g., the starting frequency domain position thereof as well as periodicity and symbol offset thereof) and SSB information of the beam candidates as the beam after next beam (second tier) (e.g., the starting frequency domain position thereof as well as periodicity and symbol offset thereof). The information may further include a difference of the frequency pre-compensation value between the serving beam and the beam candidates as the next beam (first tier) (e.g., an absolute value of the difference) and a difference of the frequency pre-compensation value between the serving beam and the beam candidates as the beam after next beam (second tier) (e.g., an absolute value of the difference). Under the proposed scheme, the assistance information may be transmitted to UE 110 in a system information block (SIB).

Under a proposed scheme in accordance with the present disclosure, during initial access, assistance information may be utilized to facilitate beam switching in connected mode and to compensate for Doppler shift. Under the proposed scheme, during initial access, assistance information corresponding to the serving beam may also indicate other information. For instance, the assistance information may indicate other information on the beams around the potential trajectory due to movement of satellite or UAS platform 130. Such other information may include, for example and without limitation, periodic tracking reference signal (TRS) (e.g., channel state information reference signal (CSI-RS) for tracking) information of the beam candidates as the next beam (first tier). This may include, for example and without limitation, scrambling ID of TRS, starting frequency domain position, and TRS bandwidth, periodicity, slot offset as well as symbol position. Such other information may also include, for example and without limitation, periodic TRS (e.g., CSI-RS for tracking) information of the beam candidates as the beam after next beam (second tier). Similarly, this may include, for example and without limitation, scrambling ID of TRS, starting frequency domain position, and TRS bandwidth, periodicity, slot offset as well as symbol position. Under the proposed scheme, a radio resource control (RRC) message may include the information of all the beams. Information of the beam candidates for the next beam as the serving beam may be delivered through medium access control (MAC) control element (CE) (e.g., down-select from RRC).

Under a proposed scheme in accordance with the present disclosure, during initial access, assistance information may be distributed in idle mode and connected mode. Under the proposed scheme, assistance information may be included in a neighbor cell list provided to UE 110. For instance, the neighbor cell list may be broadcasted in the serving beam as in SIB3 and SIB4. Alternatively, or additionally, the neighbor cell list may be unicasted to UE 110 using measurement objects. Under the proposed scheme, neighbor cell information in the neighbor cell list may provide the PCI of neighbor beams. This may be similar to operations under Release 15 (Rel-15) of the 3^{rd} Generation Partnership Project (3GPP) specification for NR to aid cell change (re-selection or handover) due to mobility of UE 110.

Under the proposed scheme, specific cell(s) in the neighbor cell list may be flagged as upcoming beams. This information may be useful in aiding cell change due to mobility of satellite or UAS platform 130 and may enable faster beam switching. Additional information such as SSB, TRS position as well as frequency pre-compensation values may be included for flagged cells as mentioned above. This may be helpful in reducing power consumption in UE 110 due to cell search and measurements, in addition to combating Doppler shift.

Under the proposed scheme, flagging of cells in the neighbor list may be tiered as mentioned above. That is, information on the next beam to arrive according to trajectory of satellite or UAS platform 130 as well as the beam after next beam, and so on, may be provided to UE 110. As an example, a flag beamTierInTrajectory provided for a neighbor cell may indicate a value of 1 in case it is the next beam according to the trajectory of satellite or UAS platform 130 or, alternatively, a value of 2 in case it is the beam after this, and so on. Beams that are not in the trajectory of satellite or UAS platform 130 following the serving beam may be assigned a special value for such a flag or, alternatively, may not be configured with the flag at all.

Under a proposed scheme in accordance with the present disclosure, during initial access, assistance information may be utilized for faster beam switching. Under the proposed scheme, assistance information corresponding to the serving beam may further indicate certain information. The information indicated may include, for example and without limitation, satellite ephemeris (e.g., trajectory and beam layout), beam center location of the serving beam, beam center location of the next beam(s) in the first tier, and beam center location of the next beam(s) in the second tier. Under the proposed scheme, the assistance information may be delivered through SIB.

Under the proposed scheme, the assistance information may vary in time. For instance, beams of the first tier and beams of the second tier may be only relevant for serving beam and may need to be updated when the serving beam changes. Moreover, beam spot center may vary with motion of satellite or UAS platform 130 assuming moving beams and, thus, beam spot center may be a function of time based on trajectory of satellite or UAS platform 130 (e.g., motion and ephemeris of satellite or UAS platform 130). Accordingly, in order to predict the next beam on the first tier and the next beam on the second tear, UE 110 may need to know its location and determine next beams from satellite information described above.

Referring to FIG. 4, scenario 400 pertains to a scenario of beam moving trajectory. In the example shown in FIG. 4, UE 110 is in the coverage of beam 6. Under a proposed scheme in accordance with the present disclosure, assistance information may indicate the information of beam 2 and beam 7 which may be the candidates as the next beam to be the serving beam for UE 110 on the first tier. The assistance information may also indicate the information of beam 3 and beam 11 which may be the candidates of the beam after next beam to be the serving beam for UE 110 on the second tier. Under the proposed scheme, when UE 110 is aware of its location and location of the beam spot center, UE 110 in beam 6 may predict beam 7 to be the next beam as the serving beam (for the first tier) and then beam 3 to be the next beam as the serving beam (for the second tier). Advantageously, under the proposed scheme, UE 110 may utilize the assistance information to achieve faster cell re-selection in RRC idle mode as well as faster beam switching in RRC connected mode.

### Illustrative Implementations

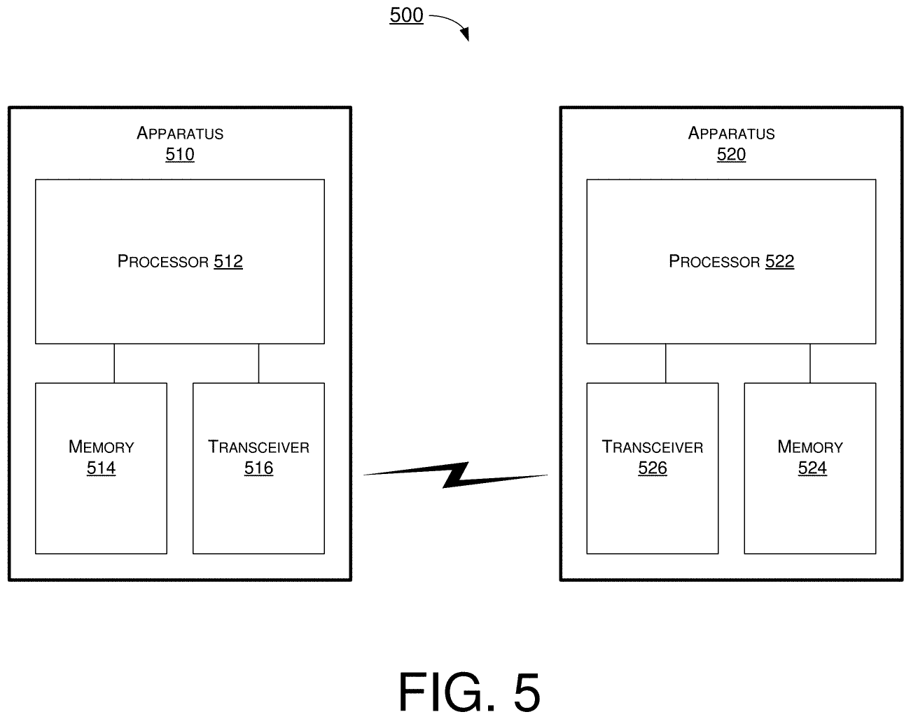

FIG. 5 illustrates an example communication environment 500 having an example apparatus 510 and an example apparatus 520 in accordance with an implementation of the present disclosure. Each of apparatus 510 and apparatus 520 may perform various functions to implement schemes, techniques, processes and methods described herein pertaining to utilization of assistance information for compensation for Doppler shift in NTNs, including various schemes described above as well as process 600 described below.

Each of apparatus 510 and apparatus 520 may be a part of an electronic apparatus, which may be a UE such as a portable or mobile apparatus, a wearable apparatus, a wireless communication apparatus or a computing apparatus. For instance, each of apparatus 510 and apparatus 520 may be implemented in a smartphone, a smartwatch, a personal digital assistant, a digital camera, or a computing equipment such as a tablet computer, a laptop computer or a notebook computer. Each of apparatus 510 and apparatus 520 may also be a part of a machine type apparatus, which may be an IoT or NB-IoT apparatus such as an immobile or a stationary apparatus, a home apparatus, a wire communication apparatus or a computing apparatus. For instance, each of apparatus 510 and apparatus 520 may be implemented in a smart thermostat, a smart fridge, a smart door lock, a wireless speaker or a home control center. Alternatively, each of apparatus 510 and apparatus 520 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. Each of apparatus 510 and apparatus 520 may include at least some of those components shown in FIG. 5 such as a processor 512 and a processor 522, respectively. Each of apparatus 510 and apparatus 520 may further include one or more other components not pertinent to the proposed scheme of the present disclosure (e.g., internal power supply, display device and/or user interface device), and, thus, such component(s) of each of apparatus 510 and apparatus 520 are neither shown in FIG. 5 nor described below in the interest of simplicity and brevity.

In some implementations, at least one of apparatus 510 and apparatus 520 may be a part of an electronic apparatus, which may be a network node or base station (e.g., eNB, gNB or TRP), a small cell, a router or a gateway. For instance, at least one of apparatus 510 and apparatus 520 may be implemented in an eNodeB in an LTE, LTE-Advanced or LTE-Advanced Pro network or in a gNB in a 5G, NR, IoT or NB-IoT network. Alternatively, at least one of apparatus 510 and apparatus 520 may be implemented in the form of one or more IC chips such as, for example and without limitation, one or more single-core processors, one or more multi-core processors, or one or more CISC or RISC processors.

In one aspect, each of processor 512 and processor 522 may be implemented in the form of one or more single-core processors, one or more multi-core processors, or one or more CISC or RISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including utilization of assistance information for compensation for Doppler shift in NTNs in accordance with various implementations of the present disclosure.

In some implementations, apparatus 510 may also include a transceiver 516 coupled to processor 512 and capable of wirelessly transmitting and receiving data. In some implementations, apparatus 510 may further include a memory 514 coupled to processor 512 and capable of being accessed by processor 512 and storing data therein. In some implementations, apparatus 520 may also include a transceiver 526 coupled to processor 522 and capable of wirelessly transmitting and receiving data. In some implementations, apparatus 520 may further include a memory 524 coupled to processor 522 and capable of being accessed by processor 522 and storing data therein. Accordingly, apparatus 510 and apparatus 520 may wirelessly communicate with each other via transceiver 516 and transceiver 526, respectively.

To aid better understanding, the following description of the operations, functionalities and capabilities of each of apparatus 510 and apparatus 520 is provided in the context of an NTN communication environment in which apparatus 510 is implemented in or as a wireless communication device, a communication apparatus or a UE (e.g., UE 110) and apparatus 520 is implemented in or as a network node (e.g., satellite or UAS platform 130).

In one aspect of utilization of assistance information for compensation for Doppler shift in NTNs in accordance with the present disclosure, processor 512 of apparatus 510 as UE 110 may receive, via transceiver 516, assistance information via an access link from apparatus 520 as a network node of NTN 100. Moreover, processor 512 may perform, via transceiver 516, an operation with respect to communications with apparatus 520 based on the assistance information.

In some implementations, the assistance information may indicate a configuration of physical signals of a serving beam spot and one or more next beam spots on the access link between apparatus 510 and apparatus 520.

In some implementations, the one or more next beam spots may correspond to beam spots on one or more beams of a first tier and one or more beams of a second tier. In such cases, one of the one or more beams of the first tier may become a serving beam for the UE due to movement of the network node before one of the one or more beams of the second tier becomes the serving beam for the UE due to the movement of the network node.

In some implementations, the assistance information may further indicate a respective beam spot center each of the serving beam spot and the one or more next beam spots as a function of a motion and an ephemeris of the network node.

In some implementations, a transmission on the access link (e.g., by apparatus 510 as UE 110) may be with a frequency re-use factor greater than 1.

In some implementations, the assistance information may indicate a PCI and a SSB configuration. In some implementations, the PCI and the SSB configuration may be indicated in a SIB. In such cases, in performing the operation, processor 512 may perform cell re-selection in an RRC idle mode.

Alternatively, or additionally, the assistance information may indicate a TRS configuration. In some implementations, the TRS configuration may be indicated in a MAC CE or an RRC information element (IE). In such cases, in performing the operation, processor 512 may perform beam switching in an RRC connected mode.

In some implementations, in performing the operation based on the assistance information, processor 512 may perform cell re-selection or beam switching based on the assistance information. In such cases, an amount of time used in performing the cell re-selection or the beam switching based on the assistance information may be shorter than an amount of time used in performing the cell re-selection or the beam switching without the assistance information.

### Illustrative Processes

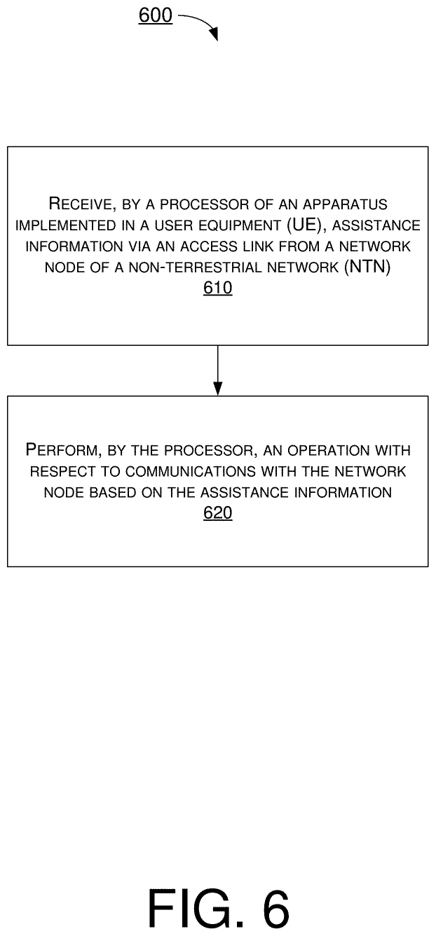

FIG. 6 illustrates an example process 600 in accordance with an implementation of the present disclosure. Process 600 may be an example implementation of the proposed schemes described above with respect to utilization of assistance information for compensation for Doppler shift in NTNs in accordance with the present disclosure. Process 600 may represent an aspect of implementation of features of apparatus 510 and apparatus 520. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Process 600 may also be repeated partially or entirely. Process 600 may be implemented by apparatus 510, apparatus 520 and/or any suitable wireless communication device, UE, base station or machine type devices. Solely for illustrative purposes and without limitation, process 600 is described below in the context of apparatus 510 as a UE (e.g., UE 110) and apparatus 520 as a network node (e.g., satellite or UAS platform 130) of an NTN (e.g., NTN 100). Process 600 may begin at block 610.

At 610, process 600 may involve processor 512 of apparatus 510, as UE 110, receiving, via transceiver 516, assistance information via an access link from apparatus 520 as a network node of an NTN. Process 600 may proceed from 610 to 620.

At 620, process 600 may involve processor 512 performing, via transceiver 516, an operation with respect to communications with apparatus 520 based on the assistance information.

In some implementations, the assistance information may indicate a configuration of physical signals of a serving beam spot and one or more next beam spots on the access link between apparatus 510 and apparatus 520.

In some implementations, the one or more next beam spots may correspond to beam spots on one or more beams of a first tier and one or more beams of a second tier. In such cases, one of the one or more beams of the first tier may become a serving beam for the UE due to movement of the network node before one of the one or more beams of the second tier becomes the serving beam for the UE due to the movement of the network node.

In some implementations, the assistance information may further indicate a respective beam spot center each of the serving beam spot and the one or more next beam spots as a function of a motion and an ephemeris of the network node.

In some implementations, a transmission on the access link (e.g., by apparatus 510 as UE 110) may be with a frequency re-use factor greater than 1.

In some implementations, the assistance information may indicate a PCI and a SSB configuration. In some implementations, the PCI and the SSB configuration may be indicated in a SIB. In such cases, in performing the operation, process 600 may involve processor 512 performing cell re-selection in an RRC idle mode.

Alternatively, or additionally, the assistance information may indicate a TRS configuration. In some implementations, the TRS configuration may be indicated in a MAC CE or an RRC IE. In such cases, in performing the operation, process 600 may involve processor 512 performing beam switching in an RRC connected mode.

In some implementations, in performing the operation based on the assistance information, process 600 may involve processor 512 performing cell re-selection or beam switching based on the assistance information. In such cases, an amount of time used in performing the cell re-selection or the beam switching based on the assistance information may be shorter than an amount of time used in performing the cell re-selection or the beam switching without the assistance information.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus implemented in a user equipment (UE), assistance information via an access link from a network node of a non-terrestrial network (NTN); and
performing, by the processor, an operation with respect to communications with the network node based on the assistance information.

2. The method of claim 1, wherein the network node comprises a satellite or an unmanned aircraft system (UAS) platform.

3. The method of claim 1, wherein the assistance information indicates a configuration of physical signals of a serving beam spot and one or more next beam spots on the access link between the UE and the network node.

4. The method of claim 3, wherein the one or more next beam spots correspond to beam spots on one or more beams of a first tier and one or more beams of a second tier, wherein one of the one or more beams of the first tier becomes a serving beam for the UE due to movement of the network node before one of the one or more beams of the second tier becomes the serving beam for the UE due to the movement of the network node.

5. The method of claim 3, wherein the assistance information further indicates a respective beam spot center each of the serving beam spot and the one or more next beam spots as a function of a motion and an ephemeris of the network node.

6. The method of claim 1, wherein a transmission on the access link is with a frequency re-use factor greater than 1.

7. The method of claim 1, wherein the assistance information indicates a physical cell identity (PCI) and a synchronization signal block (SSB) configuration.

8. The method of claim 7, wherein the PCI and the SSB configuration are indicated in a system information block (SIB), and wherein the performing of the operation comprises performing cell re-selection in a radio resource control (RRC) idle mode.

9. The method of claim 1, wherein the assistance information indicates a tracking reference signal (TRS) configuration.

10. The method of claim 9, wherein the TRS configuration is indicated in a medium access control (MAC) control element (CE) or a radio resource control (RRC) information element (IE), and wherein the performing of the operation comprises performing beam switching in an RRC connected mode.

11. The method of claim 1, wherein the performing of the operation based on the assistance information comprises performing cell re-selection or beam switching based on the assistance information, and wherein an amount of time used in performing the cell re-selection or the beam switching based on the assistance information is shorter than an amount of time used in performing the cell re-selection or the beam switching without the assistance information.

12. An apparatus implementable in a user equipment (UE), comprising:
a communication device configured to wirelessly communicate with a network node of a non-terrestrial network (NTN); and
a processor coupled to the communication device and configured to perform operations comprising:
receiving, via the communication device, assistance information via an access link from the network node; and
performing, via the communication device, an operation with respect to communications with the network node based on the assistance information,
wherein the network node comprises a satellite or an unmanned aircraft system (UAS) platform.

13. The apparatus of claim 12, wherein the assistance information indicates a configuration of physical signals of a serving beam spot and one or more next beam spots on the access link between the UE and the network node.

14. The apparatus of claim 13, wherein the one or more next beam spots correspond to beam spots on one or more beams of a first tier and one or more beams of a second tier, wherein one of the one or more beams of the first tier becomes a serving beam for the UE due to movement of the network node before one of the one or more beams of the second tier becomes the serving beam for the UE due to the movement of the network node.

15. The apparatus of claim 13, wherein the assistance information further indicates a respective beam spot center each of the serving beam spot and the one or more next beam spots as a function of a motion and an ephemeris of the network node.

16. The apparatus of claim 12, wherein a transmission on the access link is with a frequency re-use factor greater than 1.

17. The apparatus of claim 12, wherein the assistance information indicates a physical cell identity (PCI) and a synchronization signal block (SSB) configuration.

18. The apparatus of claim 17, wherein the PCI and the SSB configuration are indicated in a system information block (SIB), and wherein the performing of the operation comprises performing cell re-selection in a radio resource control (RRC) idle mode.

19. The apparatus of claim 12, wherein the assistance information indicates a tracking reference signal (TRS) configuration.

20. The apparatus of claim 19, wherein the TRS configuration is indicated in a medium access control (MAC) control element (CE) or a radio resource control (RRC) information element (IE), and wherein the performing of the operation comprises performing beam switching in an RRC connected mode.
